(19) United States
(12) Patent Application Publication
(10) Pub. No.: US 2002/0166679 A1
(43) Pub. Date: Nov. 14, 2002

(54) Rotary-contact for the transfer of electrical energy and heat energy

(76) Inventor: Andreas Lewandowski, Gottmadingen (DE)

Correspondence Address: Lewandowski Andreas, Erwin-Dietrich-Strasse 3, Gottmadingen, 78244, DE

(21) Appl. No.: 10/061,075

(22) Filed: Jan. 22, 2002

(30) Foreign Application Priority Data
Jan. 16, 2001 (DE) 101 01 879.7

(51) Int. Cl. H01B 1/00

(52) U.S. Cl. 174/1

(57) ABSTRACT

A rotating contact for the transfer of electrical energy, the transfer of heat energy or for the transfer of heat energy and electrical energy with a minimum of one fixed contact surface 9 and at least one rotating contact surface 10 as well as at least one closed gap 5 between the two contact surfaces. The gap is filled corresponding to the energy transfered with a heat conducting or electrical conducting or an electrical and heat conducting medium. The contact surfaces 9, 10 and the gap 5 can be radial or axial.

### CROSS-REFERENCE TO RELATED APPLICATIONS

A prior application copending this US-application is the German application 101 01 879.7 filed on Jan. 16, 2001.

This application concerns the invention.

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

The invention concerns a rotary contact for the transfer of electrical energy and/or heat energy.

Rotary contacts especially for the transfer of electrical energy are at a great number known in different design versions from the state of the art.

These contacts are used for the transfer of electrical energy in or out of a rotating unit. They are available in different designs.

The most common design are collector ring assemblies with brush assemblies. These collector ring assemblies consist of solid brushes in most cases carbon brushes and a slip ring. An other design of the brush assembly consists of flexible brushes such as wire or metal strip which slide on the slip ring with pretension.

In both cases the brush is pressed on the rotating collector ring. Due to the friction both parts brush and collector ring wear out. In addition the combination of the brush and the collector ring produces electrical sparks during the energy transfer.

An other possibility to transfer the electrical energy is by induction. This kind of energy transfer is known for example in DE 199.21.546 Al. This form of energy transfer is comparable to an electric motor or generator consisting of a primary and a secondary winding which are in rotary motion. The primary winding is connected to a stationary electrical source. The secondary winding is connected with the rotating unit. By the rotation the inductivity produces an electrical energy in the secondary winding. The electrical energy produced is transfered to a rotating consumer, in the case of DE 199.21.546 Al to heating elements.

The heat transfer, for example in a laminator with internal heated rollers, is in the state of the art by convection and by radiation. The heater of a laminator with internal heated rollers consists of a fixed heated axis and an outer rotating roller. Between the heating axis and the outer roller is a gap filled with air.

### BRIEF SUMMERY OF THE INVENTION

Starting from this state of the art, the invention is based on the task to set up a rotating contact for the transfer of electrical energy and/or heat energy which is wear-free, free of electrical sparks and can be produced with lower costs and hence with improved customer benefit.

This task is solved invention appropriately by a rotating contact which is made of at least one rotating and one fixed contact with a gap between which is filled with a electrical and/or heat conducting material.

Appropriate to a prefered design of the rotating contact the gap is filled with a paste-like material. Paste-like materials are especially suited because of their nature the gap can be easily sealed against the surrounding. Another advantage of paste-like mediums are that they are, like liquid mediums, in close contact to the complete surface and therefore make a good conductivity for electrical energy and/or heat energy possible.

According to the invention a rotating contact is realised with a conducting medium between the contact surfaces. This kind of energy transfer offers a wear-free connection between the fixed contact and the rotating or moving contact. Hence the wear-free and therefore abrasion-free energy transfer is especially useful in the clean room technology.

The invention appropriate rotating contact is also especially useful for the combined transfer of electrical energy and heat energy. This is necessary for example for the transfer of electrical energy in one direction and waste heat in the other direction.

Because of the closed direct contact of the conducting element with the contact surfaces, electrical sparks are avoided. This is especially useful in explosion-secured surrounding.

By integrating the gap in the components a cost reduction is possible as no additional parts like carbon brushes, spools or contact springs are necessary.

The invention appropriate rotating contact can therefore be applied in different kinds of products, for example in laminators for the transfer of electrical and heat energy or in grab arms for the transfer of electrical signals and electrical energy in explosion-secured surrounding or in the clean-room technology.

### BRIEF DESCRIPTION OF THE SEVERAL VIEWS OF THE DRAWING

Useful versions of the invention are represented in the drawing and are described in detail in the following. The drawings show:

FIG. 1 a front view of rotating contact designed as a bearing,

FIG. 2 sectional view side view of the rotating contact according to FIG. 1

FIG. 3 a perspective view of a rotating contact according to FIG. 1,

FIG. 4 a perspective view of a rotating contact for the energy conduction on a shaft,

FIG. 5 a sectional view of a rotating contact for the energy conduction on a shaft with one contact,

FIG. 6 a side view of a rotating contact according to FIG. 5

FIG. 7 a sectional view of a rotating contact for the energy conduction on a shaft with two contacts,

FIG. 8 front view of a rotating contact according to FIG. 7,

FIG. 9 a side view of a rotating contact for the conduction of heat energy of a laminator,

FIG. 10 a sectional view of a rotating contact according to FIG. 9.

FIG. 11 detail sectional view of a rotating contact according to FIG. 9.

### DETAILED DESCRIPTION OF THE INVENTION

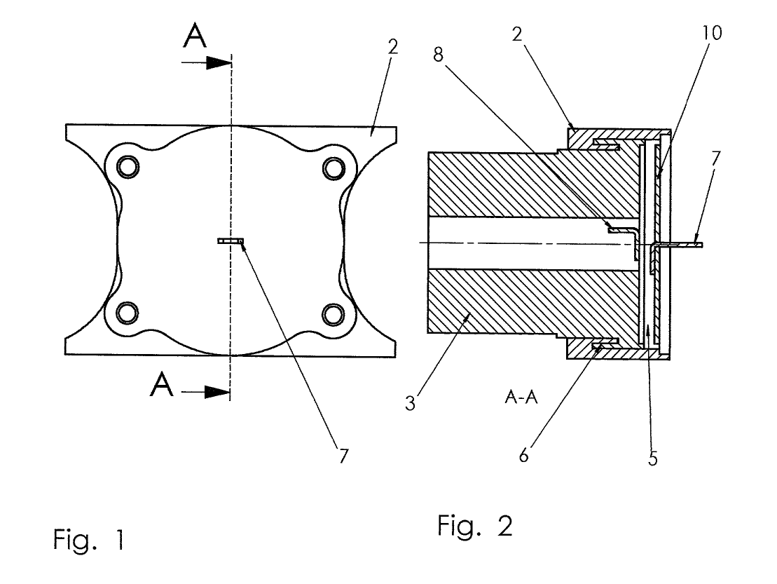

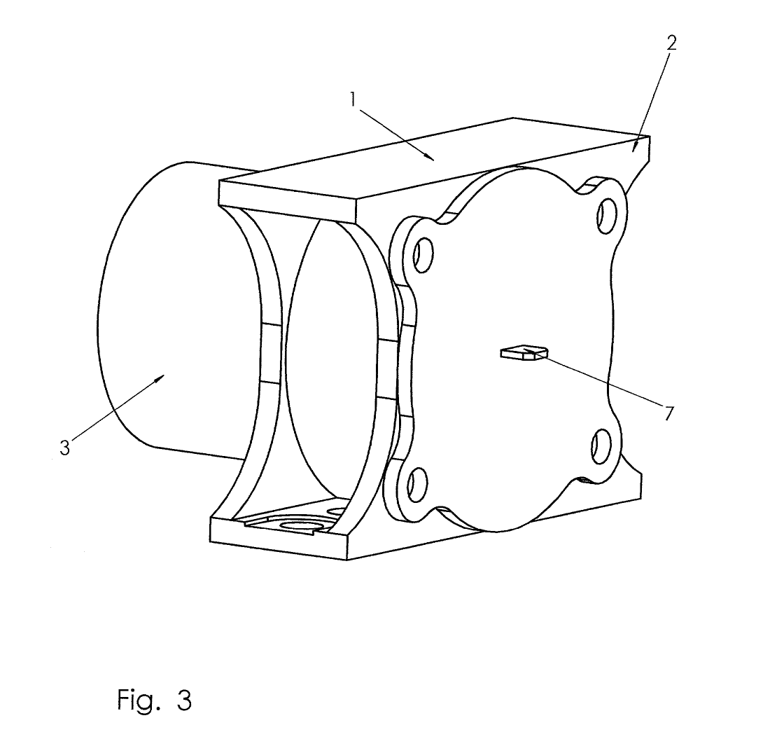

FIGS. 1 and 2 show a first invention-appropriate version of a rotating contact 1 for the conduction of electrical energy. The contact is designed as a bearing. The fixed contact is the bearing housing 2. The shaft connection 3 is the rotating contact. Both parts are in this design version made of a plastic material. The bearing housing is closed with a cover 4. Bearing housing 2, cover 4, and shaft connection 3 create a gap 5. In this design version the gap 5 is filled with electrical conducting medium. In order to seal the gap 5 to the surrounding in the contact area of bearing housing 2 and shaft connection 4 a labyrinth seal 6 is preferably in this example. Instead of the labyrinth seal 6 every other kind of shaft seals is possible like shaft seal rings or compression glands. But labyrinth seals 6 are advantageous because of their wear-freeness. The electrical conduit is from outer contact 7, via fixed contact 10, filled gap 5, rotating contact 9 to the inner contact 8.

FIG. 3 shows a perspective view of the described rotating contact 1. This version of a rotating contact offers a wear-free and cost advantageous design.

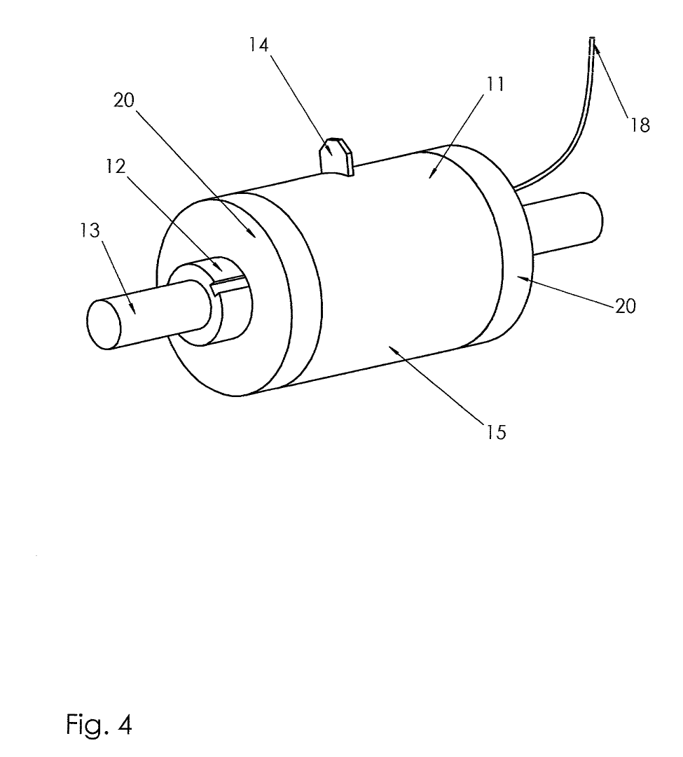

FIG. 4 shows a perspective view of a rotating shaft contact 11 for the conduction of energy on a shaft. This design version is for the transfer of electrical energy as a signal or as a supply current for an electrical consumer. The rotating contact carrier 12 are fixed on a rotating shaft 13. The fixed outer contact 14 is mounted in the contact housing 15. The shaft 13 is rotatable in the contact housing 15.

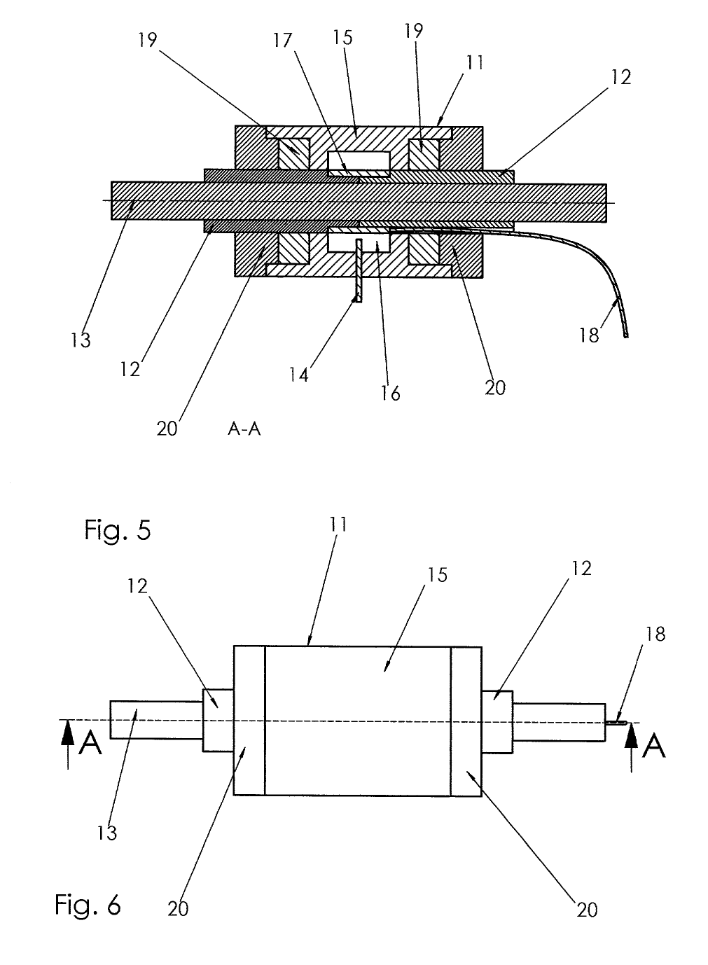

FIGS. 5 and 6 show the sectional view and the side view of the described rotating shaft contact 11. In this design version the electrical energy is transfered from fixed outer contact 14 to the wire 18 via the filled space 16 and the circular rotating contact 17. The space 16 is filled with an electrical conducting medium. In this design version the seal of the filled space 16 is a compression gland 19. The space 16 is closed by the gland ring 20. In this design version the compression gland 19 can be any other kind of shaft seal, too. Other possibilities are shaft seal rings or labyrinth seals.

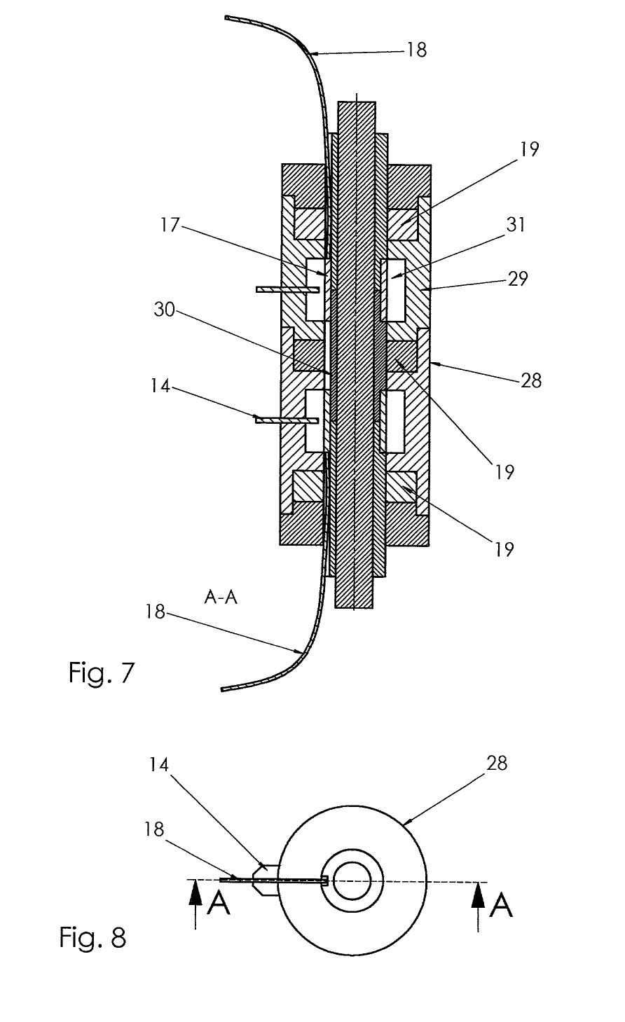

FIGS. 7 and 8 are showing a sectional view and front view of a double rotating contact 28. The rotating contact with two contacts is designed similar to the rotating shaft contact 11. But the double rotating contact 28 has an additional housing 29, an additional pipe 30, two compression glands 19, two circular rotating contacts 17, two fixed outer contacts 14 and two wires 18. The number of contacts can be increased by any value. Only the additional housing 29, the additional pipe 30, the circular rotating contact 17, the fixed outer contact 14, the compression gland 19 and the wire 18 must be added appropriately.

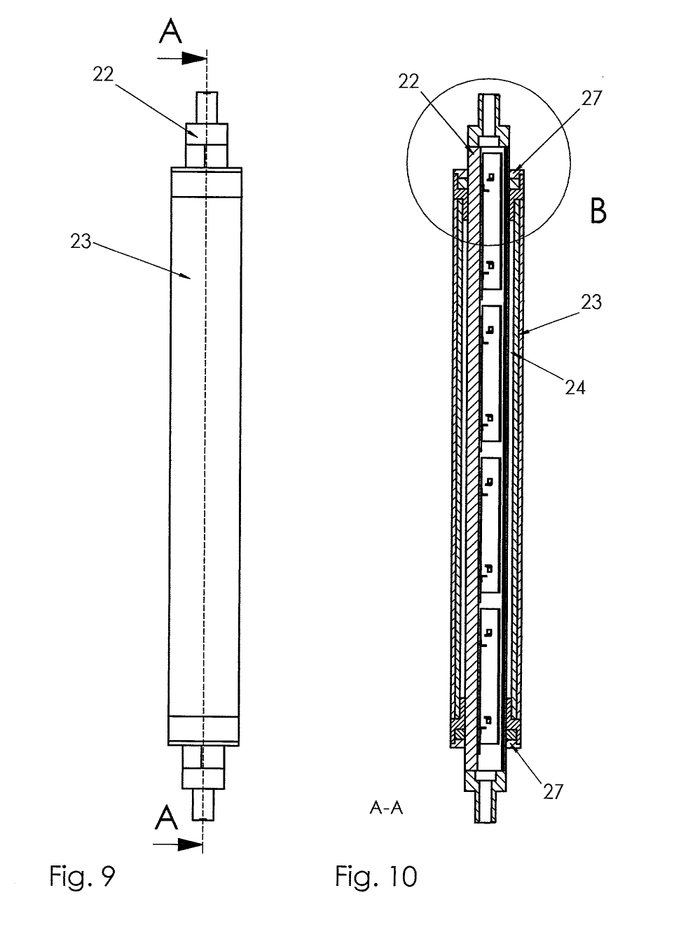

FIG. 9 and FIG. 10 are showing a side view and a sectional view of a rotating contact for the conduction of heat energy for a laminator. The rotating heat contact 21 is applied for the heat transfering connection of the heating stick 22 and the roller 23. Between the heat stick 22 and the roller 23 is a filled space 24. This space is filled with a heat conducting medium. In addition to the task heat conduction the medium makes a constant heat distribution possible. The filled space 24 is closed with the end cover 25, the compression gland 26 and the end housing 27. In this design version are other shaft seals like shaft seal rings or labyrinth seals possible, too. By applying the heat conducting medium a faster heat transfer from the heating stick 22 to the roller 23 is possible. Also a more constant outer temperature can be reached by a better heat distribution.

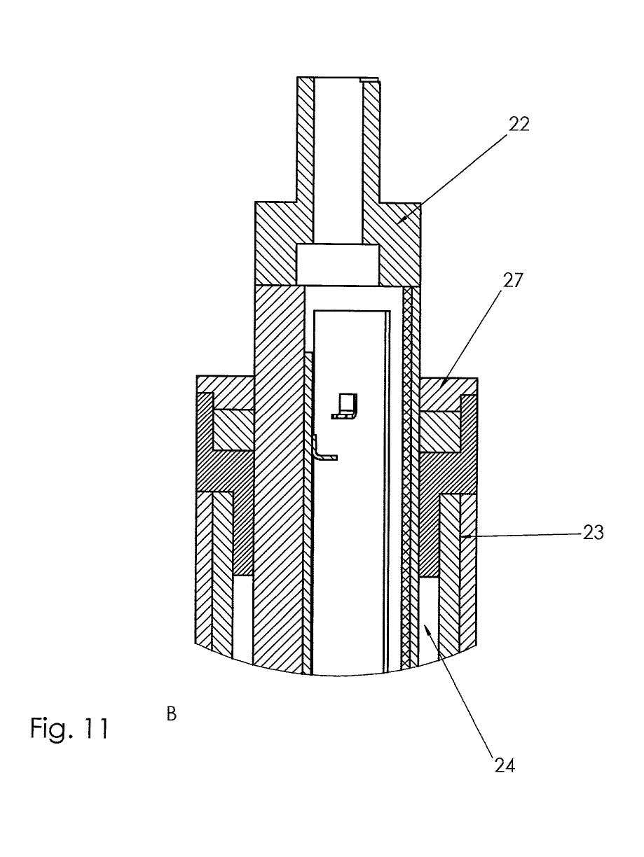

FIG. 11 shows a detail of the described sectional view of FIG. 10. This design version makes it possible to reduce the heating energy especially in the heating up period of the laminator roller. Also the laminating quality can be improved by a more accurate control system because of the faster response of the heating elements to a temperature change on the roller outer surface.

Position Mark List

1 rotating contact

2 bearing housing

3 shaft connection

4 cover

5 gap

6 labyrinth seal

7 outer contact

8 inner contact

9 rotating contact

10 fixed contact

11 rotating shaft contact

12 rotating contact carrier

13 rotating shaft

14 fixed outer contact

15 contact housing

16 space

17 circular rotating contact

18 wire

19 compression gland

20 gland ring

21 rotating heat contact

22 heating stick

23 roller

24 filled space

25 end cover

26 compression gland

27 end housing

28 double rotating contact

29 additional housing

30 additional pipe

What I claim as my invention is:

1. A rotating contact for the conduction of electrical energy and/or heat energy characterized by,
a minimum of one gap 5 between a minimum of two contacts 9 and 10,
which is filled with a heat conducting, or an electrical conducting or a heat and electrical conducting medium.

2. A rotating contact according to one of the previous claims, characterized by the rotating contact being designed as a bearing.

3. A rotating contact according to claim 2, characterized by the seal between the fixed part 2 and the rotating part 3 being a labyrinth seal.

4. A rotating contact according to claim 2, characterized by the seal between the fixed housing 2 and the rotating shaft connection 3 being designed as a shaft seal.

5. A rotating contact according to claim 2, characterized by the parts being preferably made of a plastic material.

6. A rotating contact according to claim 1, characterized by the rotating shaft contact 11 being fixed on shaft 13.

7. A rotating contact according to claim 6, characterized by the rotating shaft contact 11 having more than one pair of contacts.

8. A rotating contact according to claim 1, characterized by the rotating contact having more than one contact and more than one gap.

9. A rotating contact according to claim 1, especially for a laminator characterized by the space between the heating stick 22 and the roller 23 being filled with a heat conducting medium.

10. A flexible contact according to claim 1, characterized by at least one of the contact surfaces being flat
and at least one of the contacts making a non rotating movement.
